(19) United States
(12) Patent Application Publication
(10) Pub. No.: US 2014/0297172 A1
(43) Pub. Date: Oct. 2, 2014

(54) SAFETY DEVICE FOR MOTOR VEHICLES

(71) Applicant: ROBERT BOSCH GMBH, Stuttgart (DE)

(72) Inventor: Michael Huelsen, Herdecke (DE)

(21) Appl. No.: 14/239,717

(22) PCT Filed: Jul. 11, 2012
(86) PCT No.: PCT/EP2012/063561

§ 371 Date: Jun. 10, 2014

(30) Foreign Application Priority Data
Sep. 5, 2011 (DE) 10 2011 082 126.0

(51) Int. Cl. G08G 1/16

(52) U.S. Cl. CPC G08G 1/167; G01S 2013/9332
USPC 701/301

(57) ABSTRACT

A safety device for motor vehicles, having a sensor system for locating objects at least on one adjacent lane next to one's own lane, and having a prediction module for predicting a degree of blocking of at least one adjacent lane, the prediction module being configured for predicting a degree of blocking of the adjacent lane by hitherto non-located objects as a function of information about located objects. Also described is a method including the operations of locating an object on the adjacent lane next to one's own lane of a motor vehicle, predicting a degree of blocking of the adjacent lane by hitherto non-located objects as a function of the performed object location.

### FIELD OF THE INVENTION

The present invention relates to a safety device for motor vehicles, having a sensor system for locating objects at least on an adjacent lane next to one's own lane.

### BACKGROUND INFORMATION

A predictive safety device for motor vehicles is discussed in EP 1 992 538 A2, having a front-end sensor system for locating objects ahead of the vehicle. A control device analyzes the signals of the front-end sensor system, to evaluate the risk of an imminent collision, and intervenes in the longitudinal control of the vehicle in the event of acute collision risk. With the aid of a supplementary sensor system for monitoring the adjacent lanes and the space behind the vehicle, it may be established whether the traffic on the adjacent lanes and the following traffic permit an evasive maneuver. The supplementary sensor system includes sensors situated laterally on the vehicle, using which objects may be located, which are located approximately at the same height on the right and left adjacent to one's own vehicle.

German patent document DE 10 2006 027 326 A1 discusses a lane change assistant for motor vehicles having a sensor system for locating vehicles on adjacent lanes in the space behind one's own vehicle. Such lane change assistants are to warn the driver against veering off onto an adjacent lane if a passing vehicle is approaching on this adjacent lane from the rear, so that a collision risk or at least an obstruction of the passing vehicle would occur.

### SUMMARY OF THE INVENTION

Safety devices for motor vehicles, in particular predictive safety devices (PSS, predictive safety systems) are used, for example, for the purpose of protecting the driver from driving errors and warning him in critical situations or intervening in the longitudinal control of the vehicle, for example. Thus, braking assistants are believed to be understood, which contribute by automatically initiating a braking procedure, for example, to avoid accidents or reduce the severity thereof.

A timely recognition of a driving error places high demands on the sensor system and the analysis algorithms. The problem presents itself that a higher utility of the safety device is to be achieved by an early recognition of a driving error, while incorrect warnings are to be avoided.

### SUMMARY OF THE INVENTION

An object of the present invention is to provide a safety device for motor vehicles of the type mentioned at the outset, using which the driving safety may be increased further.

This object may be achieved according to the present invention by the safety device having a prediction module for predicting a degree of blocking of at least one adjacent lane, the prediction module being configured for the purpose of predicting a degree of blocking of the adjacent lane by hitherto non-located objects as a function of information about located objects.

Because information about located objects is used to predict the degree of blocking of the adjacent lane by hitherto non-located objects, the prediction module may improve the situational understanding of the safety device and therefore increase the reliability of the safety device. To evaluate a driving situation in the case of a collision avoidance strategy, for example, not only may the instantaneous locating data be used, but rather also the prediction of the degree of blocking of the adjacent lane by hitherto non-located objects.

The degree of blocking of the adjacent lane may specify, for example, how probable it is that the adjacent lane is blocked. This is particularly advantageous for the use in an analysis strategy, in particular a collision avoidance strategy of a safety device. In particular, a determination of such a probability may be performed based on the degree of blocking. For example, the degree of blocking of the adjacent lane may specify a prediction for the probability of colliding with an object in the event of a change to the adjacent lane.

The information about located objects may include information, in particular locating information, about objects presently located on the particular adjacent lane. The information about located objects may also include the previous degree of blocking of the particular adjacent lane.

The degree of blocking may be a multivalue value, i.e., it may assume more than two values. Graduations between the prediction “adjacent lane is free” and the prediction “adjacent lane is blocked” are thus possible. The situational understanding may be improved.

In the event of a new detection of an object, the degree of blocking may be increased, in particular increased by pulses. The increases may be additive, for example, i.e., the increase is added to the existing value, or the particular last increase may replace the previously existing value of the degree of blocking.

The term “adjacent lane” designates a strip, approximately corresponding to the vehicle width or lane width, next to one's own vehicle. This may be a further road lane in particular, or also a parking strip adjacent to the road lane or an adjacent strip of the terrain having a corresponding width. Such an adjacent lane may potentially come into consideration as an evasion path.

Furthermore, the object is achieved by a method for predicting a degree of blocking of an adjacent lane next to one's own lane of a motor vehicle, having the steps: locating an object on the adjacent lane; predicting a degree of blocking of the adjacent lane by hitherto non-located objects as a function of the performed object locating.

Further advantageous embodiments and refinements of the present invention are specified in the further description herein.

The sensor system includes, for example, a radar sensor, a lidar sensor, a video sensor, and/or a communication device for communication with other vehicles (also designated as car-to-car or car-to-X communication), to permit objects in the surroundings of the vehicle to be detected, in particular, for example, objects on adjacent lanes or on the boundaries of one's own lane. In particular, the sensor system may be configured for locating objects in the form of other traffic users. The sensor system may also be configured for locating stationary objects.

For example, the sensor system may have a front-end sensor system for locating objects at least on an adjacent lane in front of one's own vehicle, the prediction module being configured for the purpose of determining the degree of blocking of the adjacent lane as a function of the objects located by the front-end sensor system on the adjacent lane. The front-end sensor system may be used both for an adaptive cruise control (ACC) system and also for the described safety device, if it also detects the adjacent lanes.

In one specific embodiment, the prediction module is configured for the purpose of progressively decreasing the degree of blocking, during the time, after the locating of an object on the adjacent lane, in which subsequently no objects are detected on the adjacent lane. The term “progressively decreasing” includes in particular a gradual or step-by-step decrease. This has the advantage that, in a way which is particularly simple to implement, a prediction may be made, which takes into consideration the actually located objects. For example, if, on a highway, oncoming traffic occurs on the adjacent lane at regular intervals, the degree of blocking may always be set to a predefined value upon detection of an object and then gradually decreased, to then be increased again upon detection of the next object. In this way, in the event of sufficiently frequent occurrence of located objects, the blocking of the relevant lane may be permanently predicted. This is particularly advantageous for a lane having oncoming traffic, since objects on the oncoming lane are only detected briefly in the case of rapid travel and subsequently disappear again from the detection range of the sensor system.

The progressive decrease of the degree of blocking may be performed dropping linearly or exponentially, for example. The decrease may be performed, for example, down to a low limiting value of zero, for example.

In one specific embodiment, the prediction module is configured for the purpose, for example, of cumulatively increasing the degree of blocking in the event of successive locating events of multiple objects on the adjacent lane. In this way, a varying density of located objects may be taken into consideration in the prediction.

Exemplary embodiments of the present invention are illustrated in the drawings and explained in greater detail in the following description.

### BRIEF DESCRIPTION OF THE DRAWINGS

FIG. 1 shows a block diagram of a safety device for a motor vehicle.

FIG. 2 shows a sketch to explain the mode of operation of the safety device in a traffic situation.

FIG. 3 shows a diagram to explain a mode of operation of the safety device.

FIG. 4 shows a diagram to explain a different mode of operation of the safety device.

FIG. 5 shows a block diagram of a predictive safety device.

FIG. 6 shows a block diagram of a lane change assistant.

### DETAILED DESCRIPTION

The safety device shown in FIG. 1 includes a sensor system 10 in the form of a front-end sensor system for locating vehicles in front of one's own vehicle and an analysis device 12 for analyzing items of locating information of sensor system 10. Analysis device 12 includes a prediction module 14, which is configured for the purpose of predicting a degree of blocking of a left-hand adjacent lane by hitherto non-located objects as a function of information about located objects and predicting a degree of blocking of the right-hand adjacent lane by hitherto non-located objects as a function of information about located objects.

Prediction module 14 is configured for the purpose of outputting a signal L, which is based on the degree of blocking determined for the left-hand adjacent lane, and a signal R, which is based on the degree of blocking determined for the right-hand adjacent lane. Prediction module 14 accesses memories 16, 18 in a reading and writing manner for information about objects which have already been located on the particular left-hand or right-hand lane. The information about located objects may be stored, for example, in the form of an instantaneous value of the predicted degree of blocking.

The sensor system may include, in addition to the front-end sensor system, additional sensors 20, for example, sensors for locating objects laterally adjacent to one's own vehicle. Furthermore, the sensor system may include a communication device 22 for exchanging or receiving information about other vehicles or located objects in the surrounding of one's own vehicle. Such communication systems are designated, for example, as a car-to-car system or car-to-X system. They may transmit information about the position of vehicles having warning lights turned on, for example.

Furthermore, prediction module 14 may receive data from a navigation system 52 and/or from an internal vehicle sensor system 54, in order to take into consideration information about the type of the road and/or the course of the road in the determination of the degree of blocking of an adjacent lane and/or in the generation of signals L, R, as explained in greater detail hereafter.

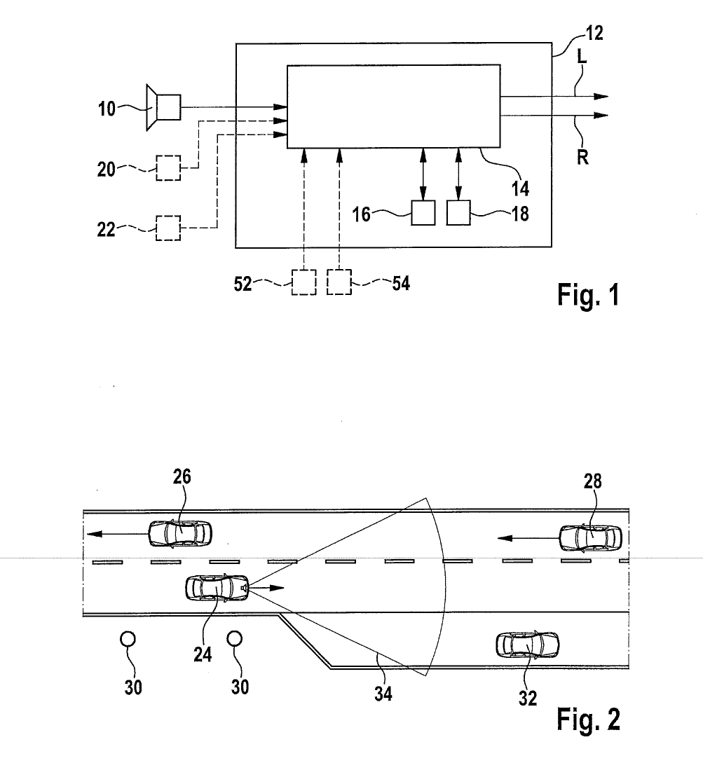

FIG. 2 shows an example of a traffic situation on a road having oncoming traffic and one lane in each case for one's own travel direction and the opposite direction. A vehicle 24, which is equipped with the safety device, travels on the right-hand road lane. Vehicles 26, 28 of the oncoming traffic come in the opposite direction on the lane, which is directly adjacent on the left. The lane which is directly adjacent on the right, i.e., a strip approximately corresponding to the vehicle width next to one's own vehicle, is not a road lane, but rather has stationary objects 30 and a parking vehicle 32.

FIG. 2 schematically shows a detection range 34 of the front-end sensor system. The detection range includes one's own road lane and the lanes which are directly adjacent on the right and left.

As an example, the mode of operation of the safety device is explained in greater detail hereafter for one of the two neighboring adjacent lanes.

Stationary objects 30 are located at short time intervals on the right-hand adjacent lane, while no object is located in the instantaneous situation shown in FIG. 2.

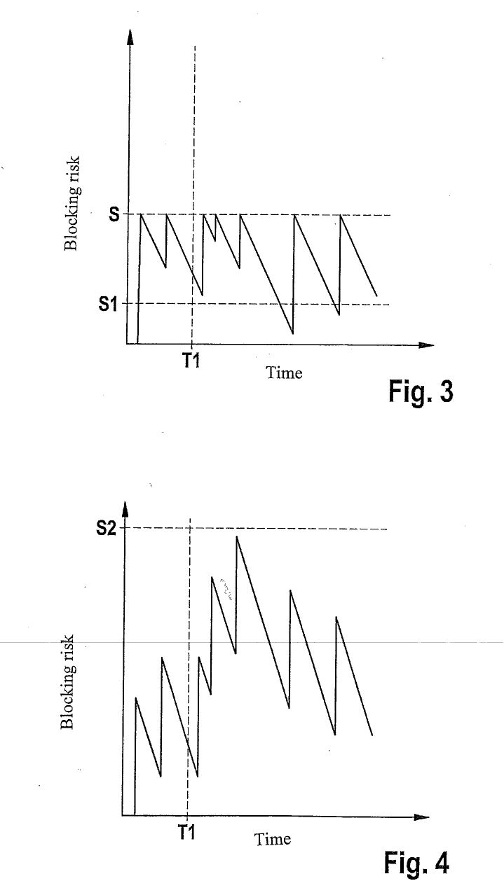

FIG. 3 schematically shows the prediction of prediction module 14 for the degree of blocking of the right-hand adjacent lane over time. The degree corresponds, for example, to the blocking risk, i.e., the probability of colliding with an object in the event of a change onto the right-hand adjacent lane. The situation shown in FIG. 2 may correspond, for example, to point in time T1 identified by a vertical dashed line in FIG. 3. In the event of the detection of one of objects 30, the degree of blocking for the right-hand road lane was set in each case to a predefined value S. In the particular following periods of time, in which no object was detected on the right-hand adjacent lane, the degree of blocking was gradually decreased by prediction module 14. In the illustrated example, the decrease was performed linearly. Prediction module 14 accesses the instantaneous value of the degree of blocking stored in memory 18 for this purpose and modifies it. At point in time T1, a moderate risk of blocking therefore exists according to the prediction of prediction module 14.

When stationary vehicle 32 is subsequently located, the degree of blocking is again set to value S. Therefore, a specific probability for a collision in the event of a possible lane change onto the right-hand adjacent lane also results for the period of time between the various locating events due to the located objects appearing at specific intervals.

In particular in the case in which presently no object is located on the relevant adjacent lane, the degree of blocking relates to blocking by hitherto non-located objects. In this regard, based on information about previously located objects, a prediction is made about the probability of the future locating of hitherto non-located objects.

The illustration of the time curve of the predicted degree of blocking is schematic, and the illustration in FIG. 2 shows the corresponding intervals of the detected objects in a way which is not to scale and not according to the time curve of the degree of blocking in FIG. 3.

Signal R may directly correspond to the degree of blocking. Alternatively, signal R may also be a two-value, binary signal, for example, and may specify whether the predicted degree of blocking has exceeded a specific threshold value. Such a threshold value S1 is shown in FIG. 3, for example.

In the described way, the predicted degree of blocking is therefore dependent on information about hitherto located objects 30, in particular on the degree of blocking based thereon, which is to be modified step-by-step. By way of the prediction of the degree of blocking, the safety device may therefore provide additional information in the form of signal R, which may be used to evaluate a driving situation, for example. While in the situation shown in FIG. 2, for example, no object is located in detection range 34 of the front-end sensor system, prediction module 14 nonetheless predicts a moderate degree of blocking of the right-hand adjacent lane. The predicted degree of blocking is at least dependent on an occurrence of a located object 30 which occurred previously.

While FIG. 3 shows a linear decrease of the degree of blocking over time, another time curve may also be established for the degree of blocking in deviation therefrom. Thus, for example, the degree of blocking may also be decreased to drop exponentially.

FIG. 4 shows a corresponding view of the degree of blocking over time for an example of a deviating way of calculating the degree of blocking. The degree of blocking is cumulatively increased here in the event of successive locating events of multiple objects on the right-hand adjacent lane. FIG. 4 corresponds to the same time curve of object locating events as FIG. 3. Point in time T1 shown in FIG. 2 is again identified in FIG. 4 by a vertical line. Due to the successive locating events of objects 30, the predicted degree of blocking at point in time T1 is not dependent on last located object 30, but rather is increased because of object 30, which was only located shortly beforehand.

The determination of the degree of blocking may be performed according to the above-described functional ways of calculating. Prediction module 14 may, however, also determine the degree of blocking with the aid of a trained machine learning method as a function of the time curve of the locating events of vehicles, for example. For example, neuronal networks (NN), classifiers such as random forest (RF), support vector machines (SVM), or hidden Markov models (HMM) may be used as machine learning methods. The machine learning method is previously trained, for example, on the basis of measured data, i.e., a chronological sequence of vehicle locating events. Optionally, the machine learning method may also be improved during operation on the basis of instantaneous locating events of vehicles.

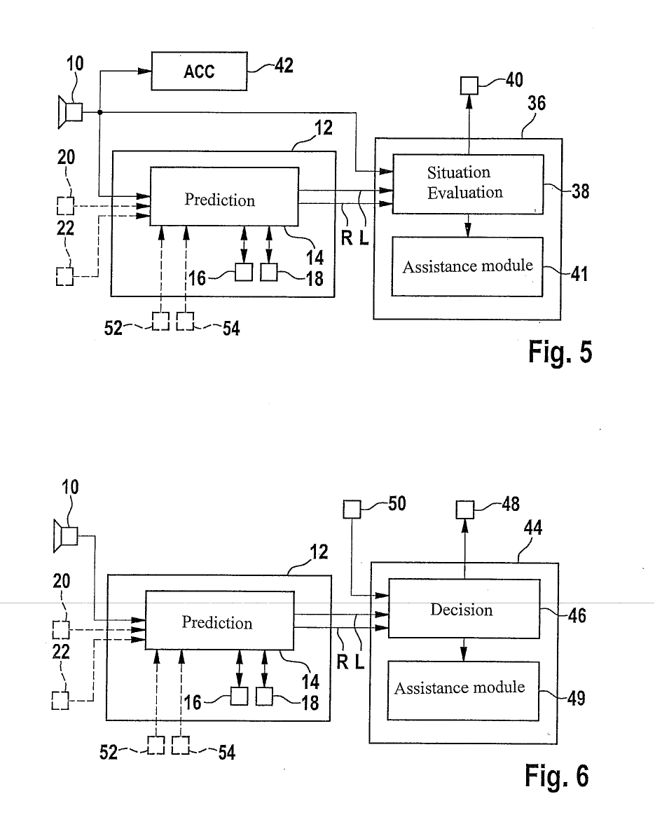

FIG. 5 shows a driver assistance system having an application of the described safety device in a predictive safety device (predictive safety system, PSS). The predictive safety device includes a control unit 36 having a situation evaluation module 38, to which the signals of the front-end sensor system are supplied. The situation evaluation module analyzes the signals of the front-end sensor system in a manner known per se, to evaluate the risk of an imminent collision. Situation evaluation module 38 is configured for the purpose of outputting a warning message to the driver via a driver interface 40 in the case of the risk of a collision. Control unit 36 is configured, for example, for the purpose of taking into consideration the predicted degree of blocking of at least one adjacent lane in the evaluation of the collision risk. For this purpose, situation evaluation module 38 receives from prediction module 14 in addition signals L, R, which are based on the particular predicted degree of blocking of the left-hand and right-hand adjacent lanes. It is configured for the purpose of outputting the warning message to the driver as a function of the predicted degree of blocking of at least one of the adjacent lanes. For example, if it is probable, based on the predicted degree of blocking of the right-hand adjacent lane, that the right-hand adjacent lane is blocked as an evasion path, an earlier warning of the driver may be performed than in the case of a right-hand adjacent lane predicted to be free.

Control unit 36 may have, in a way known per se, an assistance module 41 for triggering a reaction as a function of the collision risk. For example, assistance module 41 may be configured for the purpose of intervening in the vehicle control, in particular in the longitudinal control of the vehicle, in the event of recognized collision risk. For example, by way of assistance module 41, assistance of the vehicle control in the form of braking assistance or braking preparation may be performed and/or an intervention in the vehicle control which assists the vehicle control may be performed by the initiation of a braking procedure, for example.

The prediction of the degree of blocking of an adjacent lane by the predictive safety device therefore allows an improved situational judgment by the situation evaluation module. In particular, it may thus be taken into consideration that in the event of a blocked evasion path, running into the object located on one's own lane in front of the vehicle becomes more probable. Depending on the type of road, the left-hand and right-hand adjacent lanes may be incorporated differently into the evaluation. Thus, for example, a differentiation may be made between oncoming traffic and traffic traveling in the same direction.

The driver assistance system also optionally includes an adaptive cruise control (ACC) 42, which is configured in a way known per se for automatically regulating the distance to a vehicle traveling directly ahead in one's own lane, and which uses the front-end sensor system for this purpose, for example. The front-end sensor system may include a long-range radar sensor, for example.

FIG. 6 shows an application of the described safety device in the form of a lane change assistant 44 for motor vehicles having the safety device according to FIG. 1. Lane change assistant 44 includes a decision module 46, which is connected to a driver interface 48 for outputting a warning message to the driver. Decision module 46 is connected to prediction module 14 of the safety device and receives therefrom signals L, R, which are based on the predicted degree of blocking in the corresponding adjacent lane. Lane change assistant 44 is connected in a way known per se to a device 50 for recognizing a lane change intention of the driver and is configured for the purpose, for example, of outputting a warning message to the driver if, as a result of the traffic situation or as a result of actions of the driver such as operation of the turn signal, steering actions, and the like, it is recognizable that the driver intends a lane change and a collision risk exists. Devices for recognizing such a lane change intention of the driver are known per se and will not be described in greater detail here. The warning message may be performed visually, acoustically, and/or haptically, for example, using a lighted-up symbol, a warning tone, a steering wheel vibration, or a counter steering torque, for example.

Lane change assistant 44 may have, in a way known per se, an assistance module 49, which is connected to decision module 46, for triggering a reaction as a function of a lane change intention and an existing collision risk. For example, assistance module 49 may be configured for the purpose of intervening in the vehicle control in the event of a recognized lane change intention and blocking of the corresponding adjacent lane. For example, an assistance of the vehicle control in the form of an assisting intervention in the vehicle control, for example, a steering assistance using a counter steering torque, for example, may be performed by assistance module 49.

In the described example, decision module 46 takes into consideration signal L or signal R in the decision as to whether a warning message is output to the driver and/or assistance module 49 triggers a reaction. The warning message to the driver and/or the reaction upon recognition of an intended lane change to an adjacent lane is/are therefore performed as a function of the predicted degree of blocking of this lane. Thus, for example, in the event of predicted blocking of the lane of the oncoming traffic, a potentially dangerous passing maneuver may be warned against.

In the described examples, prediction module 14, situation evaluation module 38, and decision module 46 are formed, for example, by an electronic data processing system having suitable software.

In the described examples, prediction module 14 of the safety device may further be configured for the purpose of taking into consideration, in addition to the predicted degree of blocking of an adjacent lane, information about the type of the road, to output a signal L, R based on the degree of blocking. For example, a collision risk for an adjacent lane may be predicted based on the predicted degree of blocking and the type of road. Thus, for example, for a downtown street, an increased risk of collision may be assumed for an adjacent lane, in particular an adjacent lane next to the road, relative to a highway. For example, the road types downtown street, highway, freeway may be differentiated. Information about the type of the road may be obtained from data from a navigation system 52, for example.

Similarly to the use of information about the type of the road, information about the road course may also be used, for example, the curviness of a road. Information about the curviness may be obtained, for example, from navigation system 52 or from a signal characteristic of an internal vehicle sensor system 54, for example, from a characteristic of a steering signal of one's own vehicle from a steering signal generator of vehicle sensor system 54.

Furthermore, prediction module 14 may also be configured for the purpose of taking into consideration the types of the objects, in particular the length of the objects, when predicting the degree of blocking. Thus, for example, a long truck and a following line of vehicles could be located in the oncoming traffic. In such a case, for example, a cumulative increase of the degree of blocking due to the successive locating events may be limited in particular, since these locating events are not independent of one another. A corruption of the prediction of the degree of blocking may thus be prevented. Limiting of the degree of blocking may be performed by an upper barrier S2, as shown in FIG. 4, for example.

In a similar way, a frequency of successive locating events of various objects may be taken into consideration. Thus, a very high frequency of located objects on an adjacent lane may indicate closely parked vehicles or a line behind a truck, for example.

The features of the described examples may be combined with one another as desired. Thus, for example, a safety device may alternately include the predictive safety device having control unit 36 and/or lane change assistant 44 and may optionally be configured for the purpose of using the front-end sensor system of an ACC system 42 for locating objects on the adjacent lanes.

While the described examples include a front-end sensor system, based on the signals of which objects are located on the left-hand and right-hand adjacent lanes, another sensor system may alternatively also be used for locating objects on the adjacent lanes. The sensor system may have, for example, sensors for detecting objects on the left and right next to one's own vehicle, e.g., sensors 20.

1-12. (canceled)

13. A safety device for a motor vehicle, comprising:
a sensor system for locating objects at least on one adjacent lane next to one's own lane; and
a prediction module for predicting a degree of blocking of at least one adjacent lane;
wherein the prediction module is configured for predicting a degree of blocking of the adjacent lane by hitherto non-located objects as a function of information about located objects.

14. The safety device of claim 13, wherein the prediction module is configured for progressively decreasing the degree of blocking, during the time while, after the locating of an object on the adjacent lane, no objects are subsequently detected on the adjacent lane.

15. The safety device of claim 13, wherein the prediction module is configured for increasing, in the event of locating of an object on the adjacent lane, the degree of blocking.

16. The safety device of claim 13, wherein the prediction module is configured for setting the degree of blocking, in the event of successive locating events of multiple objects on the adjacent lane, in each case to a predefined value.

17. The safety device of claim 13, wherein the prediction module is configured for cumulatively increasing the degree of blocking in the event of successive locating events of multiple objects on the adjacent lane.

18. The safety device of claim 13, wherein the prediction module is configured for determining the degree of blocking according to a trained machine learning process as a function of locating events of objects on the adjacent lane.

19. The safety device of claim 13, wherein the degree of blocking of the adjacent lane specifies a prediction for the probability of colliding with an object in the event of a change to the adjacent lane.

20. The predictive safety device, comprising:
a front-end sensor system for locating objects ahead of the vehicle;
a control unit to analyze the signals of the front-end sensor system to evaluate the risk of an imminent collision; and
a driver interface for outputting a warning message to the driver and/or an assistance module for assisting the vehicle control;
wherein the control unit is configured for outputting a warning message to the driver and/or assisting in the vehicle control as a function of the predicted degree of blocking of an adjacent lane.

21. A lane change assistant for a motor vehicle, comprising:
a safety device, including a sensor system for locating objects at least on one adjacent lane next to one's own lane, and a prediction module for predicting a degree of blocking of at least one adjacent lane, wherein the prediction module is configured for predicting a degree of blocking of the adjacent lane by hitherto non-located objects as a function of information about located objects;
a control unit; and
a driver interface for outputting a warning message to the driver and/or an assistance module for assisting in the vehicle control;
wherein the control unit is configured for outputting a warning message to the driver and/or assisting the vehicle control as a function of the predicted degree of blocking of a neighboring adjacent lane.

22. A method for predicting a degree of blocking of an adjacent lane next to one's own lane of a motor vehicle, the method comprising:
locating an object on the adjacent lane; and
predicting a degree of blocking of the adjacent lane by hitherto non-located objects as a function of the performed object locating.

23. The method of claim 22, further comprising:
decreasing the degree of blocking, if subsequently no objects are detected on the adjacent lane.

24. The method of claim 22, further comprising:
further processing the predicted degree of blocking of the adjacent lane for situation evaluation in a driver assistance system.

25. The method of claim 22, further comprising:
further processing the predicted degree of blocking of the adjacent lane for situation evaluation in a predictive safety device or a lane change assistant.

26. The safety device of claim 13, wherein the prediction module is configured for increasing, in the event of locating of an object on the adjacent lane, the degree of blocking in pulses.
